(19) United States
(12) Patent Application Publication
(10) Pub. No.: US 2016/0147306 A1
(43) Pub. Date: May 26, 2016

(54) METHOD AND APPARATUS FOR PROVIDING HAPTIC INTERFACE

(71) Applicant: Hyundai Motor Company, Seoul (KR)

(72) Inventors: Seunghyun Woo, Seoul (KR); Gi Beom Hong, Bucheon, Gyeonggi-do (KR); Daeyun An, Anyang, Gyeonggi-do (KR)

(21) Appl. No.: 14/849,117

(22) Filed: Sep. 9, 2015

(30) Foreign Application Priority Data
Nov. 25, 2014 (KR) 10-2014-0165410

(51) Int. Cl. G06F 3/01; G06F 3/041

(52) U.S. Cl. CPC G06F 3/016; G06F 3/041

(57) ABSTRACT

A method and apparatus for providing a haptic interface that supplies air to a user button using an air control valve are provided. The apparatus includes an interaction interface unit that is configured to receive touch input and display an operation result to a screen. An air supply unit supplies air to the interaction interface unit or suctions air on top of the interaction interface unit. Additionally, a controller is configured to operate the air supply unit in order to provide haptic feedback to a user before detecting a touch of the interaction interface unit.

### CROSS-REFERENCE TO RELATED APPLICATION

This application claims priority to and the benefit of Korean Patent Application No. 10-2014-0165410 filed in the Korean Intellectual Property Office on Nov. 25, 2014, the entire contents of which are incorporated herein by reference.

### BACKGROUND

(a) Field of the Invention

The present invention relates to an apparatus and method for providing a haptic interface, and more particularly, to an apparatus for providing a haptic interface that supplies air to a user button using an air control valve.

(b) Description of the Related Art

With the variation and increase in quality of vehicle functions, various input devices for receiving various vehicle function inputs have been developed. Recently, an attempt to use a touch screen, a touch pad, and a driver information system (DIS) for the cluster or the audio video navigation (AVN) device of vehicles has been developed. Such touch interfaces are mounted within the vehicle to increase driver convenience.

However, a driver' attention may be dispersed to operate the touch interfaces. Particularly, to operate the touch interface, a driver is required to divert attention away from driving and toward the display screen even though a touch pad or a DIS is mounted on an armrest of the vehicle. A button of the touch pad cannot give an impression of a real button pushing, so the driver may not detect a position or a push degree of the button. Thus, safe drive is decreased since a diversion from the road is generated.

The above information disclosed in this section is merely for enhancement of understanding of the background of the invention and therefore it may contain information that does not form the prior art that is already known in this country to a person of ordinary skill in the art.

### SUMMARY

The present invention provides an apparatus for providing a haptic interface having advantages of supplying air to a user button using an air control valve.

An exemplary embodiment of the present invention provides an apparatus for providing a haptic interface that may include: an interaction interface unit configured to receive touch input and display an operation result to a screen; an air supply unit configured to supply air to the interaction interface unit or suction air on top of the interaction interface unit; and a controller configured to operate the air supply unit to provide haptic feedback to a user before detecting a touch of the interaction interface unit.

The interaction interface unit may include a touch pad for a vehicle. The controller may be configured to operate the air supply unit to supply or suction the air at a specific region that corresponds to coordinates of a button when at least one button is disposed on the interaction interface unit. The air supply unit may include an air control valve, and the air control valve may be configured to adjust a supply or suction amount of the air.

Further, the controller may be configured to operate the air supply unit to differentiate an amount of the air supplied or suctioned at a specific region that corresponds to coordinates of one button and another button (e.g., between two buttons) when two or more buttons are disposed on the interaction interface unit. The controller may also be configured to provide another haptic feedback by adjusting the supply or suction amount of the air when the touch of the interaction interface unit is detected. The controller may be configured to operate the air supply unit to supply or suction the air at a moving region that corresponds to scrolling coordinates when a scrolling touch of the interaction interface unit is detected.

The controller may further be configured to adjust the supply or suction amount of the air to correspond to volume of an audio device based on a touch time of the interaction interface unit when the button disposed on the interaction interface unit adjusts the volume of the audio device. Additionally, the controller may be configured to adjust the supply or suction amount of the air to correspond to temperature of an air conditioner based on a touch time of the interaction interface unit when the button disposed on the interaction interface unit adjusts the temperature of the air conditioner.

Another exemplary embodiment of the present invention provides an apparatus for providing a haptic interface, that may include: an interaction interface unit configured to receive touch input and display an operation result to a screen; an air supply unit configured to supply air to the interaction interface unit or suction air on top of the interaction interface unit; and a controller configured to operate the air supply unit to provide haptic feedback to a user at a touch point of the interaction interface unit.

The controller may further be configured to operate the air supply unit to supply or suction the air at a specific region that corresponds to the touch point of the user. The interaction interface unit may include a touch pad for a vehicle. The air supply unit may include an air control valve, and the air control valve may be configured to adjust a supply or suction amount of the air. The controller may also be configured to operate the air supply unit to supply or suction the air at a moving region that corresponds to scrolling coordinates when the scrolling touch is detected at the touch point.

As described above, according to an exemplary embodiment of the present invention, a button interface supplying or sucking air at the interaction interface may be provided, to increase user convenience and secure safe driving.

### BRIEF DESCRIPTION OF THE DRAWINGS

FIG. 1 is a schematic block diagram of an apparatus for providing a haptic interface according to an exemplary embodiment of the present invention;

FIG. 2 is a drawing showing a button of an apparatus for providing a haptic interface according to an exemplary embodiment of the present invention; and

FIG. 3 is a drawing showing scrolling of an apparatus for providing a haptic interface according to another exemplary embodiment of the present invention.

### DETAILED DESCRIPTION

In the following detailed description, exemplary embodiments of the present invention have been shown and described, simply by way of illustration. As those skilled in the art would realize, the described exemplar embodiments may be modified in various different ways, all without departing from the spirit or scope of the present invention.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, combustion, plug-in hybrid electric vehicles, hydrogen-powered vehicles and other alternative fuel vehicles (e.g. fuels derived from resources other than petroleum).

Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor. The memory is configured to store the modules and the processor is specifically configured to execute said modules to perform one or more processes which are described further below.

Furthermore, control logic of the present invention may be embodied as non-transitory computer readable media on a computer readable medium containing executable program instructions executed by a processor, controller/control unit or the like. Examples of the computer readable mediums include, but are not limited to, ROM, RAM, compact disc (CD)-ROMs, magnetic tapes, floppy disks, flash drives, smart cards and optical data storage devices. The computer readable recording medium can also be distributed in network coupled computer systems so that the computer readable media is stored and executed in a distributed fashion, e.g., by a telematics server or a Controller Area Network (CAN).

The terminology used herein is for the purpose of describing particular embodiments only and is not intended to be limiting of the invention. As used herein, the singular forms “a”, ^{an} and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Like reference numerals designate like elements throughout the specification. Further, in the drawings, a size and thickness of each element are randomly represented for better understanding and ease of description and the present invention is not limited thereto, and the thickness of several portions and areas are exaggerated for clarity.

An exemplary embodiment of the present invention will hereinafter be described in detail with reference to the accompanying drawings.

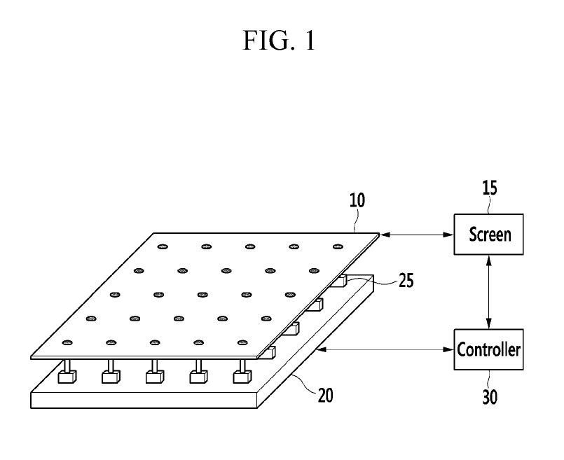

FIG. 1 is a schematic block diagram of an apparatus for providing a haptic interface according to an exemplary embodiment of the present invention. As shown in FIG. 1, an apparatus for providing a haptic interface according to an exemplary embodiment of the present invention may include an interaction interface unit 10, a screen 15, an air supply unit 20, an air control valve 25, and a controller 30. The controller 30 may be configured to operate the various units of the apparatus.

The interaction interface unit 10 may be configured to receive a touch input from a user and display an operation result to the screen 15. The interaction interface 10 may further be configured to generate an input signal due to an interaction input of the user and transmit the input signal to the controller 30. The interaction interface 10 may then be configured to display an operation result operated by the input signal to the screen 15. The interaction interface unit 10 may include a touch pad for a vehicle which may be configured to recognize a touch of the driver by measuring impedance change of a metal electrode and to transmit touch information to the controller 30. The touch pad may be mounted at an armrest or a console of the vehicle, but is not limited thereto.

Further, the interaction interface unit 10 may include a metal electrode of a vehicle interior material, a controller configured to detect capacitance, and a wire that connects the metal electrode to the controller. The interaction interface unit 10 according to an exemplary embodiment of the present invention may be made of an air transmitting material to receive air from the air supply unit 20. The interaction interface unit 10 may be coupled to the screen 15 which may be configured to receive a signal from the interaction interface unit 10 and display a visual signal.

The screen 15 may be disposed at a cluster or an audio video navigation (AVN) device of the vehicle. The screen 15 may be various display devices such as a plasma display panel (PDP), a liquid crystal display (LCD), a light emitting polymer display (LPD), and an organic light emitting diode (OLED). In addition, the air supply unit 20 may be configured to supply air to the interaction interface unit 10 or suction air on top of the interaction interface unit 10. The air supply unit 20 may include the air control valve 25 configured to adjust a supply or suction amount of the air. The air supply unit 20 may be mounted at a lower part of the interaction interface unit 10, but is not limited thereto. Moreover, the air supply unit 20 may be constituted by an air pump or a compressor, but is not limited thereto.

As described above, since the interaction interface unit 10 may be made of an air transmitting material, the air supply unit 20 may be configured to supply the air to the interaction interface unit 10 or suction the air on top of the interaction interface unit 10 through the air control valve 25. The controller 30 may be configured to operate the air supply unit 20 to provide haptic feedback to a user before detecting a touch of the interaction interface unit 10. The controller 30 may further be configured to operate the air supply unit 20 to supply or suction the air at a specific region that corresponds to coordinates of a button (e.g., supply or suction air where the button is disposed) when at least one button selecting menu is provided on the interaction interface unit 10.

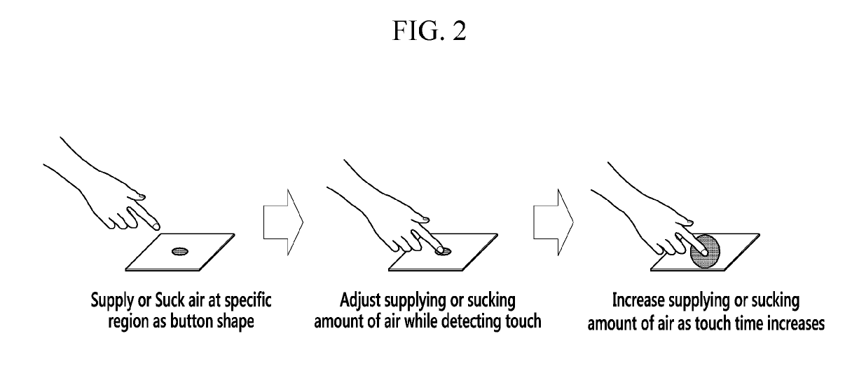

FIG. 2 is a drawing showing a button of an apparatus for providing a haptic interface according to an exemplary embodiment of the present invention. Referring to FIG. 2, when at least one button selecting menu is provided on the interaction interface unit 10, the air supply unit 20 may be configured to supply or suction the air at a specific region formed as a button shape that corresponds to coordinates of the button based on a control signal of the controller 30.

In particular, the controller 30 may be configured to provide another haptic feedback to a user by adjusting a supply or suction amount of the air through the air control valve 25 when a touch of the interaction interface unit 10 is detected. For example, when the button disposed on the interaction interface unit 10 is engaged (e.g., pushed, or engaged in another manner by, for example, a user) for a substantial period of time (e.g., about one second), the controller 30 may be configured to increase the supply or suction amount of the air or expand the specific region (e.g., the region that corresponds to the coordinates of the button). In addition, the controller 30 may be configured to operate the air supply unit 20 to supply or suction the air at a moving region that corresponds to a scrolling coordinate when a scrolling touch of the interaction interface unit 10 is detected. The scrolling touch of the interaction interface unit 10 may be detected when the button provided on the interaction interface unit 10 adjusts volume of an audio device or temperature of an air conditioner. The prevent invention, however, is not limited to the adjustment of the volume or temperature but may include other vehicle function adjustments that may be operated by a button.

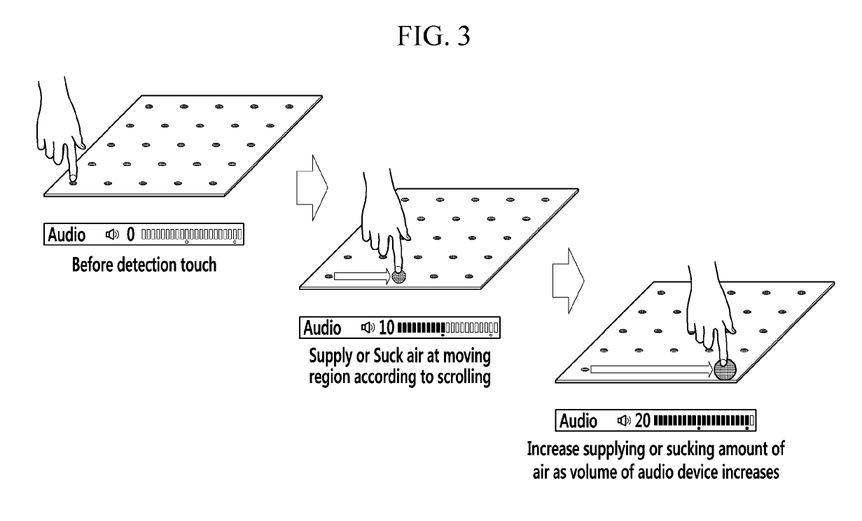

FIG. 3 is a drawing showing scrolling of an apparatus for providing haptic interface according to another exemplary embodiment of the present invention. Referring to FIG. 3, the air supply unit 20 may be operated to supply or suction the air at a moving region that corresponds to scrolling coordinates as the user scrolls through the interaction interface unit 10 (e.g., a pressure on the interaction interface unit 10 is moving along the screen). Accordingly, when the volume of an audio device or the temperature of an air conditioner is increased based on scrolling on the interaction interface unit 10, the controller 30 may be configured to adjust the supply or suction amount of the air to correspond to the volume of the audio device or the temperature of the air conditioner.

As described above, according to an exemplary embodiment of the present invention, a button interface supplying or suctioning air at the interaction interface may be provided, to improve user convenience and ensure safer driving.

While this invention has been described in connection with what is presently considered to be exemplary embodiments, it is to be understood that the invention is not limited to the disclosed exemplary embodiments. On the contrary, it is intended to cover various modifications and equivalent arrangements included within the spirit and scope of the appended claims.

### DESCRIPTION OF SYMBOLS

10: interaction interface unit

15: screen

20: air supply unit

25: air control valve

30: controller

What is claimed is:

1. An apparatus for providing a haptic interface, comprising:
an interaction interface unit configured to receive a touch input and display an operation result to a screen;
an air supply unit configured to supply air to the interaction interface unit or suction air on top of the interaction interface unit; and
a controller configured to operate the air supply unit to provide haptic feedback to a user before detecting a touch of the interaction interface unit.

2. The apparatus of claim 1, wherein the interaction interface unit includes a touch pad for a vehicle.

3. The apparatus of claim 1, wherein the controller is configured to operate the air supply unit to supply or suck the air at a specific region that corresponds to coordinates of a button when at least one button is provided on the interaction interface unit.

4. The apparatus of claim 1, wherein the air supply unit includes an air control valve configured to adjust a supply or suction amount of the air.

5. The apparatus of claim 4, wherein the controller is configured to operate the air supply unit to differentiate an amount of the air supplied or suctioned at a specific region that corresponds to coordinates of multiple buttons when two or more buttons are provided on the interaction interface unit.

6. The apparatus of claim 4, wherein the controller is configured to provide another haptic feedback by adjusting the supply or suction amount of the air when the touch of the interaction interface unit is detected.

7. The apparatus of claim 6, wherein the controller is configured to operate the air supply unit to supply or suction the air at a moving region that corresponds to scrolling coordinates when a scrolling touch of the interaction interface unit is detected.

8. The apparatus of claim 6, wherein the controller is configured to adjust the supply or suction amount of the air to correspond to volume of an audio device based on a touch time of the interaction interface unit when the button provided on the interaction interface unit adjusts the volume of the audio device.

9. The apparatus of claim 6, wherein the controller is configured to adjust the supply or suction amount of the air to correspond to temperature of an air conditioner based on a touch time of the interaction interface unit when the button provided on the interaction interface unit adjusts the temperature of the air conditioner.

10. An apparatus for providing a haptic interface, comprising:
an interaction interface unit configured to receive touch input and display an operation result to a screen;
an air supply unit configured to supply air to the interaction interface unit or suction air on top of the interaction interface unit; and
a controller configured to operate the air supply unit to provide haptic feedback to a user at a touch point of the interaction interface unit.

11. The apparatus of claim 10, wherein the controller is configured to operate the air supply unit to supply or suction the air at a specific region that corresponds to the touch point of the user.

12. The apparatus of claim 10, wherein the interaction interface unit includes a touch pad for a vehicle.

13. The apparatus of claim 10, wherein the air supply unit includes an air control valve configured to adjust a supply or suction amount of the air.

14. The apparatus of claim 13, wherein the controller is configured to operate the air supply unit to supply or suction the air at a moving region that corresponds to scrolling coordinates when the scrolling touch is detected at the touch point.

15. A method for providing a haptic interface, comprising:
receiving, by a controller, a touch input of an interaction interface unit to display an operation result to a screen;
supply, by the controller, air to the interaction interface unit or suction air on top of the interaction interface unit; and
provide, by the controller, haptic feedback to a user before detecting a touch of the interaction interface unit.

16. The method of claim 15, wherein the interaction interface unit includes a touch pad for a vehicle.

17. The method of claim 15, further comprising:
supplying or suctioning, by the controller, the air at a specific region that corresponds to coordinates of a button when at least one button is provided on the interaction interface unit.

18. The method of claim 15, further comprising:
differentiating, by the controller, an amount of the air supplied or suctioned at a specific region that corresponds to coordinates of multiple buttons when two or more buttons are provided on the interaction interface unit.
